(19) United States
(12) Patent Application Publication
(10) Pub. No.: US 2010/0026032 A1
(43) Pub. Date: Feb. 4, 2010

(54) PASSENGER AUTOMOBILE HAVING AN ADJUSTABLE SEAT OF A MIDDLE SEAT ROW

(75) Inventor: Frank LEOPOLD, Taunusstein-Orlen (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/494,974

(22) Filed: Jun. 30, 2009

(30) Foreign Application Priority Data
Jun. 30, 2008 (DE) 102008031015.8

(51) Int. Cl. B60N 2/30; B60N 2/01; B60N 2/06; B60N 2/12; B60N 2/22

(52) U.S. Cl. 296/64

(57) ABSTRACT

A passenger automobile, in particular a van, is provided having three seat rows situated one behind another in the vehicle longitudinal direction, the middle seat row having at least one seat adjustable as a whole in the vehicle longitudinal direction, which has a seat part and a backrest part, which is settable and fixable at an angle to the seat part, and a footwell being formed in front of the seat located in the usage position. The seat with unchanged position of seat part and backrest part is positionable in a nonusage position in the footwell. In such a vehicle, the third seat row is well accessible through the vehicle door which is situated in the area of the second seat row. Independently of mounted child seats on the second seat row, it is possible to pass through the vehicle door associated with the second seat row to the rear to the third seat row.

### CROSS-REFERENCE TO RELATED APPLICATION

This application claims priority to German Patent Application No. 102008031015.8, filed Jun. 30, 2008, which is incorporated herein by reference in its entirety.

### TECHNICAL FIELD

The invention relates to a passenger automobile, in particular a van, having three seat rows situated one behind another in the vehicle longitudinal direction, the middle seat row having at least one seat adjustable as a whole in the vehicle longitudinal direction, which has a seat part and a backrest part, which is settable and fixable at an angle to the seat part, and a footwell being formed in front of the seat located in the usage position.

### BACKGROUND

Passenger automobiles, in particular vans, of the type cited are known in manifold forms from practice. Therein, the seats of the front seat row—driver seat and passenger seat—are accessible through doors associated with the seats. The seats of the middle seat row are also accessible through doors associated with this seat row. Furthermore, the access to the third, rear seat row occurs via these doors.

With an implementation of this type, in particular the entry to the third seat row is hardly possible when child seats are mounted on the seats of the second seat row, the situation being typical, however, for example, during a children's excursion. To enter to the third seat row, it is necessary to change the angle of the backrest part to the seat part of the particular seat of the middle seat row.

In passenger automobiles, in particular vans, efforts are made to provide a large-dimensioned cargo space in the vehicle, with minimal wheelbase and comfortable seats. In known designs, it is provided that seats are removed for this purpose, or backrest parts of the seats of the middle seat row are folded forward. Removal of the seat is complex and connected to significant effort for the operator, notwithstanding the disadvantage of operating errors when installing the seat and the requirement of storing the removed seat separately. In contrast, if only the backrest part is folded down to form an enlarged cargo space, a cargo situation having a cargo floor at a relatively high level results, so that the elevated cargo space can only be used relatively inadequately.

At least one object of the present invention is to refine a passenger automobile of the type cited at the beginning in such a way that the third seat row is well accessible through a vehicle door which is situated in the area of the second seat row. Independently of mounted child seats on the second seat row, it is to be possible to pass through to the rear to the third seat row through the vehicle door associated with the second seat row. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved in a passenger automobile of the type cited at the beginning in that the seat, with unchanged position of seat part and backrest part, is positionable in the footwell in a nonusage position.

According to an embodiment of the invention, it is thus provided that the seat of the second seat row, without a change of the position of the backrest part to the seat part being performed, is transferred from the usage position into the nonusage position. The seat is partially situated in the footwell in the nonusage position. This means that in this nonusage position, the seat part of the seat plunges into the footwell at least in its forward area. In this way, a certain inclination of the seat results, in particular with the consequence that with unchanged position of the backrest part to the seat part, the support face of the backrest part and/or the backrest part is situated essentially vertically. The backrest part can thus be positioned at a small distance to the backrest part of the seat of the front seat row. In this way, sufficient space is provided behind the backrest part of the seat of the second seat row so that the possibility exists of passing readily through the door associated with the second seat row to the rear to the third seat row of the passenger automobile. In the nonusage position, the surface of the seat part of the seat in the middle seat row is oriented inclined downward to the front in particular relative to the horizontal. This plunging situation of the seat part upon the transfer into its nonusage position forms the condition for folding of the backrest part of this seat to achieve a cargo level of the cargo floor which is then formed at a relatively low cargo level.

The displaceability of the seat, specifically the seat part, may be implemented in various ways. It is viewed as especially advantageous if the seat part is mounted via a rail guide and/or a rocker mount in the vehicle floor. Using the rail guide and/or the rocker mount, the complete seat, whether it is the left seat or the right seat, may be displaced forward toward the front seat.

Under the aspect of forming the cargo space in the area of the seat of the second seat row, it is seen as especially advantageous if the seat part and the backrest part are implemented separately, but are connected to one another. Preferably, bearing blades are connected to the seat part on both sides of the seat part for the mounting, in particular the pivotable mounting of the backrest part, the bearing blades being settable and fixable relative to the seat part. The bearing blades which are used for mounting the backrest part may thus be situated in different positions relative to the seat part and fixed therein and thus predetermine a fundamental mounting position of the backrest part in the bearing blades, the backrest part preferably being able to assume different positions relative to the bearing blades.

It is thus provided according to a preferred refinement of the invention that the bearing blades receive the backrest part so it is pivotable around an axis, this axis being situated parallel to the pivot axis of the bearing blades in the seat part. In particular, the pivot axis of the backrest part is situated in the bearing blades, relative to the usage position of the seat, between the upper free end of the backrest part and the pivot axis of seat part and bearing blades, in particular approximately at half the distance of pivot axis from seat part and bearing blades and from pivot axis of the backrest part. In a preferred pivot position of the backrest part relative to the bearing blades, the backrest part is situated essentially vertically, relative to the usage position and/or nonusage position of the seat formed by the seat part and the backrest part. In the other pivot position, the backrest part is positioned to form the cargo space floor in the area of this seat. The backrest part and the bearing blades are preferably fixable to one another, in particular fixable to one another by locking. In this way, a unique assignment of backrest part and bearing blades is ensured in different positions of the backrest part relative to the bearing blades.

According to a special design, it is provided that when the bearing blades are pivoted to the rear, the backrest part mounted so it is pivotable in the bearing blades is situated essentially horizontally, to form a section of the cargo space floor of the vehicle with the rear side of the backrest part directed upward. In this position of the backrest part, its upwardly directed rear side preferably essentially forms a plane with a rear side, which is directed forward, of a backrest part, which is folded forward, of a seat of the rear seat row and/or a plane with a rear side, which is directed forward, of a backrest part, which is folded forward, of a seat of the front seat row. In this way, a cargo space floor may be provided, which extends essentially over the entire length of the interior of the vehicle, for example, from a rear hatch of the vehicle up to the dashboard of the passenger seat.

The embodiments of the invention thus propose a seat folding of the seat of the second seat row, which is advantageous in regard to improved boarding of the third seat row and the formation of a cargo space floor at a relatively low level. For this purpose, the seats of the second seat row may be folded independently of the seats of the third seat row. The particular seat of the second seat row no longer has to be changed in the angle between seat part and backrest part for entry to the third seat row. The complete seat is displaced forward toward the associated front seat. Accordingly, this seat is moved out of the entry area for the rear seat row. The separate implementation of seat part and backrest part ensures that the seat can be handled as a whole, seat part and backrest part still being connected for safety reasons, however. This is performed using the upwardly projecting bearing blades fastened on the seat part, which receive the backrest part in an articulated way at approximately half height, the backrest part locking with the bearing blades. Upon disengagement of the locking, the bearing blades fall essentially into the horizontal, in order to move the backrest part to the rear. Because the backrest part is mounted so it is pivotable around an axis, the backrest part also can fall into the horizontal, but without overlapping with the seat part or the seat of the third seat row facing toward it. A uniform distribution of the seat volume at the lowest level is thus achieved. It is advantageous in the bearing blades that, when viewed laterally, they do not project out of the seat contour and are entirely capable of receiving the outer armrests. This variant is used in particular in sliding door vehicles. The weight of the armrest may thus contribute to an automatic lowering of the backrest part into the lowest possible position, the backrest part being situated between the backrest part of the seat of the folded third row facing toward it and the backrest part of the associated front seat.

The design described in the scope of the invention allows the total exploitation of the interior around the driver as a uniform surface. In this way, greatly manifold configurations and combinations of passenger transport or cargo transport are possible. It is also possible to load through extremely long objects supported up to the front.

The design additionally allows the seat to be transferred into the particular function using one-hand operation. After the unlocking, the seat is brought into its final position with one movement. This occurs in particular in that for the entry to the third seat row, only a forward movement of the entire seat of the second seat row occurs. If one wishes to improve the remaining space for entry still further, it suggests itself that the seat part be designed in such a way that a seat cushion of the seat part is connected in an articulated way to a base frame of the seat part so it can be raised, whereby upon striking the front seat, depending on its position, the backrest part of the seat of the second seat row can rest thereon and thus the greatest possible increase in space is achieved.

### BRIEF DESCRIPTION OF THE DRAWINGS

The present invention will hereinafter be described in conjunction with the following drawing figures, wherein like numerals denote like elements, and:

FIG. 1 shows a passenger automobile according to an embodiment of the invention, which is implemented as a van, for the area of the vehicle interior having three seat rows, in section in the vehicle longitudinal direction and essentially illustrated for the usage position of the seats of the three seat rows; and

FIG. 2 shows the illustration of the van from FIG. 1, illustrated for the nonusage position of seats of the three seat rows.

### DETAILED DESCRIPTION

The following detailed description is merely exemplary in nature and is not intended to limit application and uses. Furthermore, there is no intention to be bound by any theory presented in the preceding background or summary or the following detailed description.

The figures show the external contour of the passenger automobile 1 having the door cutout 2 for the passenger door, the door cutout 3 for the vehicle door situated behind the passenger door, and a side window 4 located in the area of the rear seat row. Furthermore, the side sill 5, the passenger-side B-column 6, and the cargo space 7, which is delimited at the rear by a loading hatch 8 of the vehicle, are shown.

The figures illustrate the front seat row 9—first seat row—which is accessible through the door cutout 2, the middle seat row 10—second seat row—which is accessible through the door cutout 3, and the rear seat row 11—third seat row—which is situated behind the middle seat row 10. Only the passenger seat 12 is shown for the front seat row 9 and only the vehicle seats 13 and 14 situated behind the passenger seat 12 are shown for the other seat rows 10 and 11.

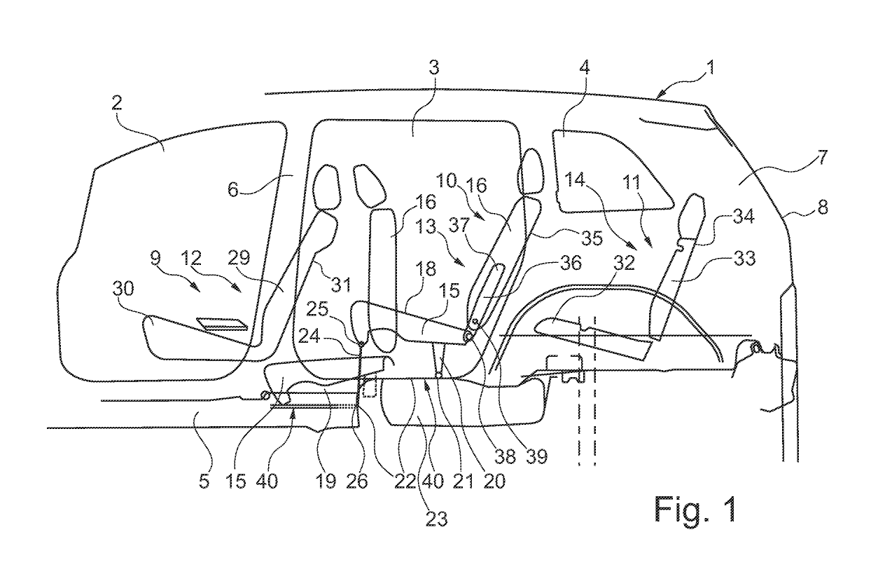

The seat 13 of the middle seat row 10 has a seat part 15 and a backrest part 16, which is settable and fixable at an angle to the seat part 15. This seat 14 is illustrated in FIG. 1 in its rear usage position and in its front nonusage position. In the rear usage position, the backrest part 16 is situated having its headrest 17 inclined slightly to the rear relative to the vertical and the surface 18 of the seat part 15, starting from the corner formed by the seat part 15 and the backrest part 16, is inclined slightly upward relative to the horizontal. In the nonusage position, in contrast, the backrest part is positioned essentially vertically and the seat part 15 is oriented having its surface 18 inclined downward and slightly forward. In this nonusage position, the seat part 15 is positioned in the footwell 19, which, relative to the usage position of the seat 13, is situated in front of the seat between the two side sills 5 of the vehicle. Specifically, the seat part 15 projects partially into the footwell 19.

To cause the movement of the seat 13 and thus the seat part 15 from the usage position of the seat 13 into its nonusage position, the seat part 15 is mounted at the rear, on both sides, via rigid pedestal elements 20, which receive guide elements 21, such as guide rolls, on the bottom, in parallel guide rails 22 situated in the vehicle longitudinal direction. The particular guide rail 22 lies on the floor 40 of the vehicle interior, which extends over different levels, in a section above the fuel tank 23, and extends in the floor 40 vertically downward into the footwell 19, it pressing against the floor 40 of the vehicle interior, adjacent to the fuel tank 23. The seat part 15 has connecting rods 24 in the area of its front, lower ends on both sides. The particular connecting rod 24 is mounted in the area of its one end via a pivot bearing 25 in the seat part 15 and in the area of its other end via a pivot bearing 26 in the vehicle floor 40 in the area of the footwell 19, the pivot axes of the pivot bearings 25 and 26 running in the transverse direction of the vehicle.

Upon transfer of the seat 13 from the usage position into the nonusage position, the seat part 15 thus pivots via the connecting rods 24 around the fixed pivot axis of the pivot bearing 26 and the seat part 15 travels via the guide element 21 in the guide rail 22 up to the vehicle floor 40 in the area of the footwell 19. In this nonusage position, the particular connecting rod 24 is oriented essentially horizontally.

It may be inferred from FIG. 1 that to transfer the seat 13 from the usage position into the nonusage position, it is not necessary to change the position of backrest part 16 to seat part 15. It is only necessary to move the seat 13 forward as a whole, because of the predetermined kinematics, a pivot movement resulting of the seat 13 counterclockwise relative to the illustration of FIG. 1.

In the nonusage position according to FIG. 1, the rear seat row 11 is ergonomically favorably accessible through the door cutout 3.

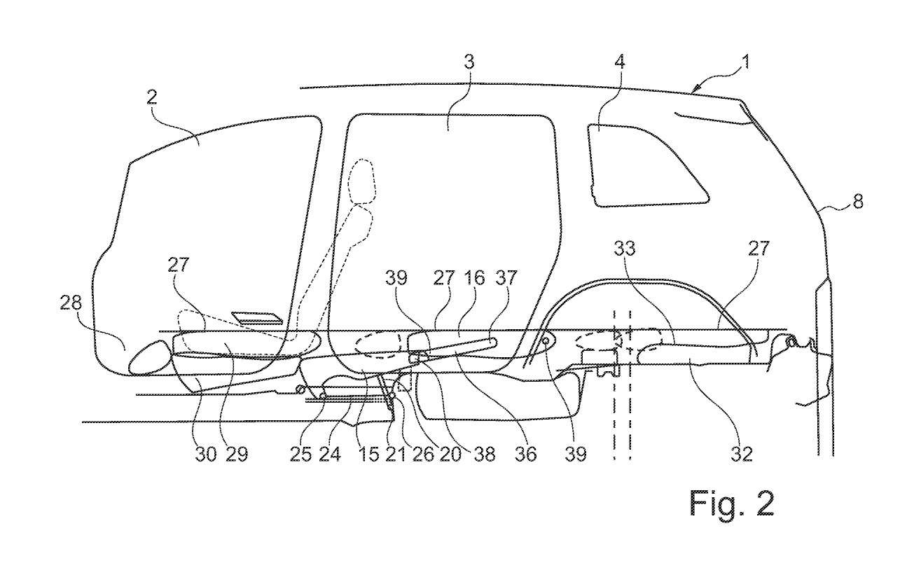

In contrast to the usage positions of the seats or seat rows of the vehicle illustrated in FIG. 1, the illustration of FIG. 2 shows the special folding ability of the seats situated on the right side, thus the passenger side of the vehicle, of the three seat rows to achieve a level cargo space floor 27, which reaches from the rear of the vehicle up to the footwell 28 in front of the passenger seat. Thus, as may be inferred from the comparison of FIG. 1 and FIG. 2, the backrest part 29 of the passenger seat is folded onto the seat part 30 of this seat and the seat part 30 is moved forward and downward. As may be inferred from the illustration of FIG. 2, in the folded-together position of the passenger seat 12, the rear face 31 of the backrest part 29 of the passenger seat 12 is oriented horizontally, and at a relatively low level because of the lowered seat part 30.

The right seat 14 of the rear seat row 11 may be folded together correspondingly. In regard to this seat 14, its seat part 32 folded downward and the backrest part 33 of this seat 13 resting on the seat part 32 are illustrated. The rear face 34 of this backrest part 33 in the usage position forms the cargo space floor 27 in this area in the folded-together position of the vehicle seat 14, which is at the level of the cargo space floor 27 in the area of the backrest part 29 of the passenger seat 12.

The rear face 35 of the backrest part 16 of the right driver seat 13 of the middle seat row 10 may also be folded to this level, so that a continuous level cargo space floor surface results, as may be inferred from FIG. 2.

The folding of the vehicle seat 13 of the middle seat row 10 is performed on the basis of the following details of the design of this vehicle seat 13.

The seat part 15 of the seat 13 has, on both sides of the seat part 15, bearing blades 36 for the pivotable mounting of the backrest part 16. The particular bearing blade 36 situated on one side of the backrest part 16 is connected to the seat part 15 and is settable and fixable relative to the seat part 15. The particular bearing blade 36 receives the backrest part 16 so it is pivotable around an axis 37. This axis 37 is situated parallel to the pivot axis 38 of the bearing blade 36 in the seat part 15. The pivot axis 37 of the backrest part 16 in the bearing blade 36 is, relative to the usage position of the seat 13, situated between the upper free end of the backrest part 16 and the pivot axis 38 of seat part 15 and bearing blade 36, in particular at approximately half the distance of pivot axis 38 from seat part 15 and bearing blade 36 and from pivot axis 37 of the backrest part 16 in the bearing blade 36. The backrest part 16 and the particular bearing blade 36 are fixable to one another, in particular by engaging with one another. The lock element active between the bearing blade 36 and the backrest part 16 is identified by the reference numeral 39. In addition, further lock elements may be active between the particular bearing blade 36 and the backrest part 16, which lock the backrest part 16 in the position shown in FIG. 2 relative to the particular bearing blade 36.

Upon disengagement of the locks situated on both sides of the seat 13 between the two bearing blade 36 and the seat part 15 and between the two bearing blade 36 and the backrest part 16, on the one hand, the bearing blades 36 may fall to the rear into the horizontal position and is possible for the backrest part 16 to pivot counterclockwise around the axis 37, relative to the illustration of FIG. 1 and FIG. 2, so that the final position of the backrest part 16 shown in FIG. 2 and, upon displacement of the seat part 15, also the final position of the lowered seat part 15 shown in this figure, are achieved. The backrest part 16 is oriented in this final position having its lower end toward the cargo hatch 8 of the vehicle relative to the usage position.

The transfer of the seats of the three seat rows from the position forming the cargo space floor shown in FIG. 2 into the usage position shown in FIG. 1 is performed in reverse.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A passenger automobile, comprising:
a first seat row;
a second seat row situated behind the first seat row in a longitudinal direction of the passenger automobile, the second seat row comprising a seat adjustable as a whole in the longitudinal direction that has a seat part and a backrest part, which is settable and fixable at an angle to the seat part, and a footwell formed in front of the second seat row located in a usage position, wherein the second seat row with an unchanged position of the seat part and the backrest part can be positioned in the footwell in a nonusage position; and
a third seat row situated behind the second seat row in the longitudinal direction of the passenger automobile;

2. The passenger automobile according to claim 1, wherein a surface of the seat part is oriented inclined forward and downward relative to the horizontal in the nonusage position.

3. The passenger automobile according to claim 1, wherein a support surface of the backrest part is situated essentially vertically in the nonusage position.

4. The passenger automobile according to claim 1, wherein the seat part is mounted in a floor of the passenger automobile with a rail guide.

5. The passenger automobile according to claim 1, wherein the seat part and the backrest part are implemented separately and connected to one another.

6. The passenger automobile according to claim 1, wherein a plurality of bearing blades are connected to the seat part on both sides of the seat part for the mounting, the plurality of bearing blades settable and fixable relative to the seat part.

7. The passenger automobile according to claim 6, wherein the plurality of bearing blades are adapted to receive the backrest part and pivotable around an axis situated substantially parallel to a pivot axis of the plurality of bearing blades in the seat part.

8. The passenger automobile according to claim 7, wherein the pivot axis of the backrest part in the plurality of bearing blades, relative to the usage position is situated in the plurality of bearing blades between an upper free end of the backrest part and the pivot axis and the plurality of bearing blades at approximately half a distance of the pivot axis from the seat part and the plurality of bearing blades and from the pivot axis of the backrest part.

9. The passenger automobile according to claim 6, wherein the backrest part and the plurality of bearing blades are fixable to one another.

10. The passenger automobile according to claim 9, wherein the backrest part and the plurality of bearing blades are fixable to one another in the usage position that forms a component of a cargo space floor of the passenger automobile.

11. The passenger automobile according to claim 6, wherein with the plurality of bearing blades pivoted to a rear, the backrest part mounted in the plurality of bearing blades, is situated essentially horizontally to form a section of a cargo space floor with a rear side of the backrest part directed upward.

12. The passenger automobile according to claim 6, wherein an armrest is mounted in one of the plurality of bearing blades.

13. The passenger automobile according to claim 11, wherein the backrest part having a rear side directed upward essentially forms a plane with a second rear side that is directed forward of a second backrest part that is folded forward of the third seat row that is directed upward of a third backrest part that is folded forward of the first seat row.
